(19) United States
(12) Patent Application Publication
(10) Pub. No.: US 2005/0220108 A1
(43) Pub. Date: Oct. 6, 2005

(54) Frame based MAC control in WLAN communication devices

(75) Inventors: Ralf Flemming, Dresden (DE); Matthias Baer, Hohenstein-Ernstthal (DE); Uwe Eckhardt, Dresden (DE); Ulrich Hensel, Dresden (DE); William Kern, Palo Alto, CA (US); Stephan Rosner, Campbell, CA (US)

Correspondence Address: MEYERTONS, HOOD, KIVLIN, KOWERT & GOETZEL, P.C., P.O. BOX 398, AUSTIN, TX, 78767-0398, US

(73) Assignee: Advanced Micro Devices, Inc.

(21) Appl. No.: 10/939,859

(22) Filed: Sep. 13, 2004

(30) Foreign Application Priority Data
Mar. 31, 2004 (DE) 10 2004 015 861.4

(51) Int. Cl. H04L 12/26; H04L 12/56; G06F 11/00

(52) U.S. Cl. 370/392; 370/412; 370/252; 370/338

(57) ABSTRACT

A WLAN (Wireless Local Area Network) communication device and method are provided where a MAC (Medium Access Control) control unit controls access to a wireless medium. The MAC control unit is capable of selectively applying any one of at least two different control mechanisms to data to be transmitted. The data received from a target system comprises data frames, each having associated an individual control header comprising control information. The control information specifies at least one control mechanism to be applied to data of the associated data frame. The MAC control unit extracts control information from each control header associated to a data frame, and selects a control mechanism specified by the extracted control information.

### BACKGROUND OF THE INVENTION

1. Field of the Invention

The invention generally relates to WLAN (Wireless Local Area Network) communication devices and methods and particularly to a MAC (Medium Access Control) control technique in WLAN systems.

2. Description of the Related Art

A wireless local area network is a flexible data communications system implemented as an extension to or as an alternative for, a wired LAN. Using radio frequency or infrared technology, wireless LANs transmit and receive data over the air, minimizing the need for wired connections. Thus, wireless LANs combine data connectivity with user mobility.

Most WLAN systems use spread spectrum technology, a wide-band radio frequency technique developed for use in reliable and secure communication systems. The spread spectrum technology is designed to trade-off bandwidth efficiency for reliability, integrity and security. Two types of spread spectrum radio systems are frequently used: FHSS (Frequency Hopping Spread Spectrum) and DSSS (Direct Sequence Spread Spectrum) systems.

The standard defining and governing wireless local area networks that operate in the 2.4 GHz spectrum, is the IEEE 802.11 standard. To allow higher data rate transmissions, the standard was extended to the 802.11b standard that allows data rates of 5.5 and 11 Mbps in the 2.4 GHz spectrum. This extension is backwards compatible as far as it relates to direct sequence spread spectrum technology, but it adopts a new modulation technique called CCK (Complementary Code Keying) which allows the speed increase.

Further extensions to the IEEE 802.11 standard exist. For instance, the IEEE 802.11a and 802.11g specifications use the OFDM (Orthogonal Frequency Division Multiplexing) technique which is a wireless transmission technique that splits signals into sub signals that are then transmitted at different frequencies simultaneously. The 802.11g version of ODFM uses a combination of BPSK (Binary Phase Shift Keying), QPSK (Quadrature Phase Shift Keying), and QAM (Quadrature Amplitude Modulation), depending on the chosen data rate.

An example of a conventional WLAN transceiver device is the Am1772 wireless LAN chip set which is depicted in FIG. 1. As apparent from the figure, the device comprises a baseband/MAC (Medium Access Control) unit 100 which includes a baseband section 110 and an MAC section 115. Both sections are connected via a baseband/MAC interface unit 120 which is media independent.

The MAC section 115 comprises an input/output bus host interface which is connected via an I/O bus to an external I/O bus host interface 180. The input/output bus host interface of the MAC section 115 is further connected to a frame composer 145 and a timer 150.

The baseband section 110 comprises baseband inner and outer receiver units 125, 130 and a baseband transmitter unit 135 to perform baseband data processing in both directions. Baseband data processing refers to signal processing after having shifted the frequency from the radio frequency domain in the reception path, and before doing the shift in the transmission path. The baseband section 110 further comprises a control logic 140 for controlling the baseband receiver and transmitter units 125, 130, 135 and the baseband/MAC interface unit 120.

The WLAN transceiver device of FIG. 1 further comprises an RF (Radio Frequency) transceiver 105 that is connected to the baseband/MAC unit 100 to interchange data which is received or which is to be transmitted. As the interchanged data is digital data, the RF transceiver 105 comprises digital-to-analog converters 165, 170 in the transmission path and analog-to-digital converters 155, 160 in the reception path. The reception path further comprises an LNA (Low Noise Amplifier) and an AGC (Automatic Gain Control) unit for selectively adjusting the reception gain. Further, there is a VCO (Voltage Controlled Oscillator) unit which is connected to a PLL (Phase Locked Loop) unit.

As apparent from FIG. 1, the WLAN transceiver device further comprises a power amplifier 185 which receives an analog output signal to be transmitted, from the RF transceiver 105. The power amplifier 185 is controlled by the control logic 140 of the baseband section 110 in the baseband/MAC unit 100 via a power amplifier control signal. The control logic 140 further provides a transmitter/receiver switch signal to switch operation of the device between a reception mode and a transmission mode. Further, the control logic 140 provides an antenna switch signal for selecting one of two (or more) antennae 190.

Generally, WLAN communication devices include some MAC control hardware such as the MAC section 115 of FIG. 1 that may generally allow to serve incoming requests in many different ways. For instance, some security mechanisms for authentication or encryption tasks can be added, an RTS/CTS (Request to Send/Clear to Send) mechanism can be applied, different preamble modes exist, and so on. To specify which of these mechanisms are to be applied, i.e. to specify the way of how an individual service is actually to be used, the MAC control unit needs to receive a large amount of control information. This can lead to severe disadvantages in many cases.

For instance, the various different services and applications require to evaluate the control information at different points in time. Thus, the entity (e.g. the host) providing the control information needs to distinguish the services and mechanisms to decide on the suitable point in time to provide the control information. This may lead to a severe control overhead which can even cause reliability problems. If the entity providing the control information chooses to reduce the overhead by sending the control information more frequently (rather than at the correct point in time required by the service or application), the bandwidth required to exchange the control information is drastically increased.

### SUMMARY OF THE INVENTION

An improved medium access control technique for WLAN communication devices is provided which may eliminate additional control efforts for the control information providing entity (such as the host) to decide on the point in time to update the control information.

In one embodiment, a WLAN transmitter device is provided that comprises a transmission buffer for buffering data received from a target system, where the buffered data comprises data to be transmitted over a wireless medium, and a MAC control unit for controlling access to the wireless medium. The MAC control unit is capable of selectively applying any one of at least two different control mechanisms to data to be transmitted. The data received from the target system comprises data frames each having associated an individual control header comprising control information. The control information specifies at least one control mechanism to be applied to data of the associated data frame. The MAC control unit is arranged to extract control information from each control header associated to a data frame, and select a control mechanism specified by the extracted control information.

In another embodiment, there is provided an integrated circuit chip that comprises a transmission buffer circuit for buffering data received from a target system. The buffered data comprises data to be transmitted over a wireless medium. The integrated circuit chip further comprises a MAC control circuit for controlling access to the wireless medium. The MAC control circuit is capable of selectively applying any one of at least two different control mechanisms to data to be transmitted. The data received from the target system comprises data frames each having associated an individual control header comprising control information. The control information specifies at least one control mechanism to be applied to data of the associated data frame. The MAC control circuit is arranged to extract control information from each control header associated to a data frame, and select a control mechanism specified by the extracted control information.

According to a further embodiment, a method of operating a WLAN transmitter device comprises receiving data from a target system where the data comprises data to be transmitted over a wireless medium, buffering the received data, and controlling access to the wireless medium by selectively applying any one of at least two different control mechanisms to data to be transmitted. The data received from the target system comprises data frames each having associated an individual control header comprising control information. The control information specifies at least one control mechanism to be applied to data of the associated data frame. In the method, controlling access to the wireless medium comprises extracting control information from each control header associated to a data frame, and selecting a control mechanism specified by the extracted control information.

According to still a further embodiment, there is provided a computer readable storage medium storing instructions that, when executed on a processor, calls the processor to associate individual control headers to individual data frames to be sent to a WLAN communication device. The individual control headers contain control information specifying at least one of at least two different control mechanisms to be applied to data of the associated data frame by a MAC control unit of the WLAN communication device.

According to yet another embodiment, a method of controlling operation of a WLAN communication device is provided. The method comprises associating individual control headers to individual data frames to be sent to the WLAN communication device. The individual control headers contain control information specifying at least one of at least two different control mechanisms to be applied to data of the associated data frame by an MAC control unit of the WLAN communication device. The method further comprises sending the data frames and associated control headers to the WLAN communication device.

### BRIEF DESCRIPTION OF THE DRAWINGS

The accompanying drawings are incorporated into and form a part of the specification for the purpose of explaining the principles of the invention. The drawings are not to be construed as limiting the invention to only the illustrated and described examples of how the invention can be made and used. Further features and advantages will become apparent from the following and more particular description of the invention, as illustrated in the accompanying drawings, wherein:

FIG. 1 is a block diagram illustrating a conventional WLAN communication device;

FIG. 2 is a block diagram illustrating components involved in performing the MAC control according to an embodiment;

FIG. 3 is a block diagram illustrating a burst of frames having control headers according to an embodiment;

FIG. 4 is a block diagram illustrating components of a programmable MAC hardware unit according to an embodiment;

FIG. 5 is a flow chart illustrating the data transmission process according to an embodiment; and

FIG. 6 is a flow chart illustrating the process of performing a software control on the MAC control unit according to an embodiment.

### DETAILED DESCRIPTION OF THE INVENTION

The illustrative embodiments of the present invention will be described with reference to the figure drawings wherein like elements and structures are indicated by like reference numbers.

As apparent from the detailed description of the various embodiments below, control headers are built to each data frame. In an embodiment, a microcontrollerless WLAN hardware extension is provided that can be programmed on a per frame basis.

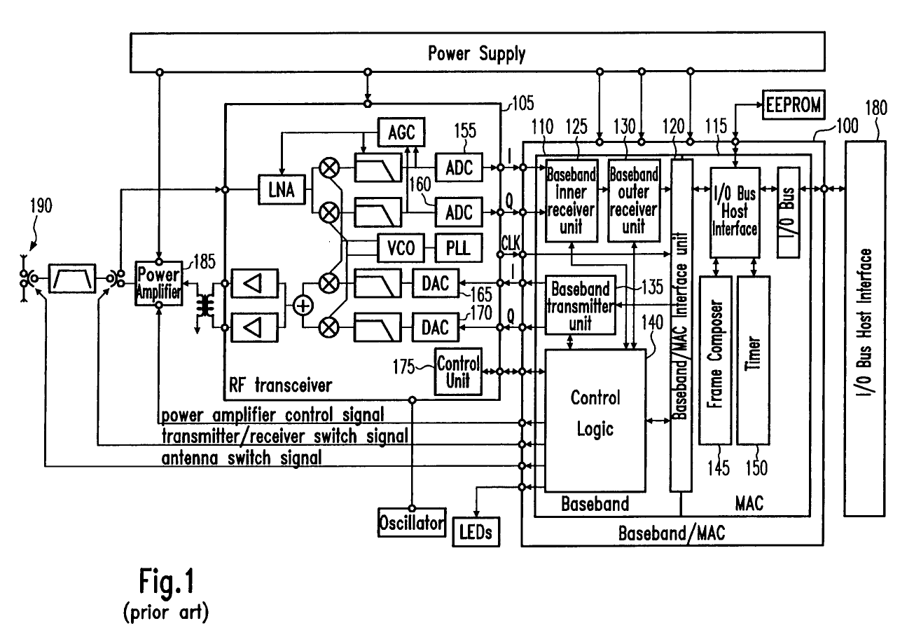

In an embodiment, the control headers are built by software and are used to program the hardware protocol machine of the MAC section such as that of the device shown in FIG. 1. The data frames may be MSDU (MAC Service Data Unit) and/or MMPDU (MAC Management Protocol Data Unit) data frames. Thus, the embodiments build control headers by software to each MSDU/MMPDU request. The requests consisting of the frame to be sent and the built control header may then be enqueued into a hardware queue. The hardware may then be informed about the new request to serve. The host may also provide several MSDU/MMPDU requests in a burst and inform the hardware about the burst and where to find the start of it.

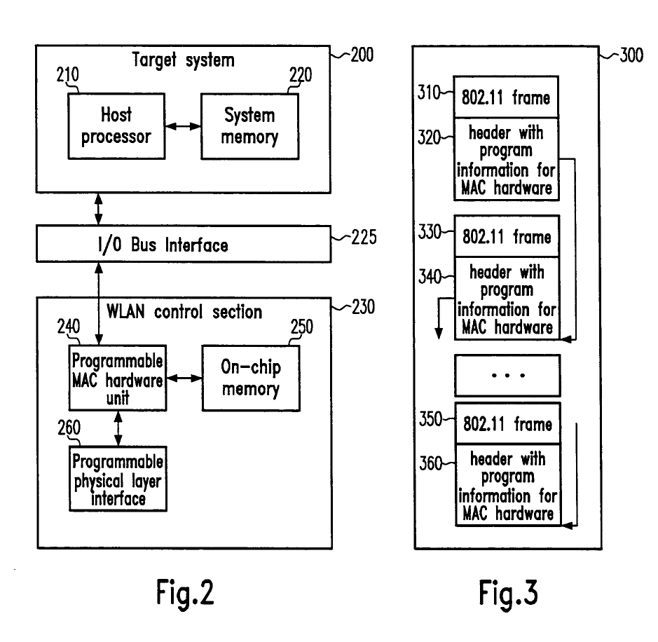

Referring now to the drawings and particularly to FIG. 2, a block diagram of the components involved is shown. As apparent from FIG. 2, a WLAN control section 230 is provided which may be implemented as hardware circuits in the WLAN communication device such as a transmitter or transceiver. The WLAN control section 230 is connected to the target system 200 via an I/O bus interface 225. In one embodiment, I/O bus interface 225 may be similar or equivalent to I/O bus host interface 180 shown in FIG. 1. Further, I/O bus interface 225 may in different embodiments be, or may not be, connected directly to the host processor 210, dependent on the possibility to enable DMA (Direct Memory Access) access into the system memory 220.

The connection between the WLAN control section 230 and the target system 210 may be a PCI (Peripheral Component Interconnect), CF (Compact Flash), SD (Secure Digital), or SRAM (Static Random Access Memory) compliant interface. In further embodiments, other interface technologies may be used.

As shown in FIG. 2, the target system 200 has a host processor 210 which has access to system memory 220. In target systems which do not allow DMA access to the system memory 220, the host processor 210 is the unit that controls sending and receiving data to and from the I/O bus interface 225.

The WLAN control section 230 comprises a programmable MAC hardware unit 240 and a programmable physical layer interface 260. Further, there may be an on-chip memory 250 provided in the WLAN control section 230. The on-chip memory 250 may be optionally provided depending on throughput and latency of the host bus, i.e. the I/O bus interface 225.

In an embodiment, the programmable MAC hardware unit 240 is configurable but microcontrollerless. That is, the programmable MAC hardware unit 240 of this embodiment does not include a microcontroller but nevertheless has the capability of being programmed. In an embodiment, this is accomplished by one or more state machines which can be influenced by control information. For this purpose, the programmable MAC hardware unit 240 can receive program information that may cause the programmable MAC hardware unit 240 to execute a specified sequence of instructions in the performance of a desired operation or group of operations. This will become more apparent from the following description of the various embodiments.

It is to be noted that the programmable physical layer interface 260 may have the same or similar programmability capabilities as the programmable MAC hardware unit 240.

Referring now to FIG. 3, a burst of data frames 310, 330, 350 having associated control headers 320, 340, 360 is shown. In the embodiment of FIG. 3, the data frames 310, 330, 350 include data in a data format which is IEEE 802.11 compliant (which may include any extension of this standard). The control headers 320, 340, 360 are headers including program information for the programmable MAC hardware unit 240. In another embodiment, the control headers 320, 340, 360 include any control information that specifies at least one of at least two different control mechanisms to be applied by the programmable MAC hardware unit 240. Further, the control headers 320, 340, 360 may include control or program information for the programmable physical layer interface 260.

It is to be noted that the data frames 310, 330, 350 having associated control headers 320, 340, 360 are enqueued in a hardware queue 300 which may be realized by the on-chip memory 250 of the WLAN control section 230. It is further to be noted that the data frame/control header queue shown in FIG. 3 may be the same, in a further embodiment, when implemented in the system memory 220 of the target system 200.

As shown in FIG. 3, the enqueued associated control headers 320, 340, 360 may point to a respective next data frame in the queue. For this purpose, there may be a pointer field provided in each control header. Further, the control headers may comprise information indicating the length of the respective next data frame to which the pointer points.

In an embodiment, the control headers 320, 340, 360 may further comprise a tag field that indicates which one of the enqueued data frames 310, 330, 350 is presently in service. The tag field may be used to operate the hardware queue like a wrap round counter.

As described above, the control headers 320, 340, 360 may include control information specifying a control mechanism. In one embodiment, the control mechanism may be a data security algorithm that is to be applied to data of the respective associated data frame 310, 330, 350. Such data security algorithms may include any authentication or encryption algorithm that is applicable in WLAN communication devices. In particular, data security may include TKIP (Temporal Key Integrity Protocol) and/or WEP (Wired Equivalent Privacy) mechanisms in an embodiment.

Another example of a control mechanism that may be specified by the control information given in control headers 320, 340, 360, may be an RTS/CTS frame control mechanism. In this embodiment, each individual control header 320, 340, 360 may specify whether an RTS frame (or a CTS frame) is to be transmitted prior to the respective associated data frame 310, 330, 350.

A further example of a control mechanism according to an embodiment is a preamble control mechanism. In this embodiment, the control information provided in control headers 320, 340, 360 may indicate whether a preamble is to be transmitted prior to the respective associated data frame 310, 330, 350. In addition, the control information may specify a specific preamble type control mechanism for selecting a preamble type to be transmitted prior to the respective associated data frame 310, 330, 350. In an embodiment, a preamble type may be a short preamble (in contrast to a long preamble).

Further, a control mechanism specified by the control information in the control headers 320, 340, 360 may be a unicast control mechanism in an embodiment. That is, the control information may specify in this embodiment whether the respective associated data frame 310, 330, 350 is to be transmitted as unicast data frame (and not as multicast or broadcast data frame).

In further embodiments, the control headers 320, 340, 360 may comprise transmitter statistics data. In another embodiment, the transmitter statistics data is not part of the control information used to configure the MAC hardware but gathered and uploaded as information by the host.

The transmitter statistics data may hold status information indicating whether a service was cancelled, successfully finished, or is not yet finished. Further, the transmitter statistics data may hold transmission retry information. In another embodiment, the transmitter statistics data may hold time stamp information taken at the transmission end of the last transmission.

In another embodiment, the transmitter statistics data may hold previously received RSSI (Received Signal Strength Indication) information. This RSSI information may be derived from a previously received acknowledgement message.

Further, the transmitter statistics data may hold signal quality information pertaining to a previously received acknowledgement frame. Further, the transmitter statistics data may hold antenna selection information which may again pertain to a previously received acknowledgement frame.

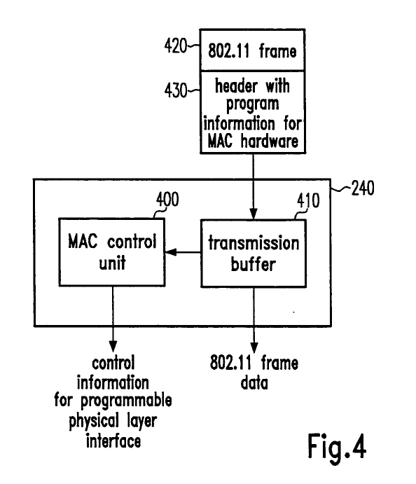

Referring now to FIG. 4, the programmable MAC hardware unit 240 is depicted in more detail. As apparent from the figure, the programmable MAC hardware unit 240 comprises a MAC control unit 400 and a transmission buffer 410. The transmission buffer 410 receives the data frame 420 with its associated control header 430. The data frame 420 and the control header 430 may be a single data frame/control header, or may be a data frame/control header which is part of a burst such as that of FIG. 3. In any case, the control header 430 may include any information discussed above with respect to FIG. 3.

The transmission buffer 410 of the programmable MAC hardware unit 240 buffers the received data and outputs the 802.11 compliant frame data which is to be transmitted over the wireless medium, to the programmable physical layer interface 260.

The MAC control unit 400 extracts the control information from the control header 430 and selects a control mechanism specified by the extracted information. Further, the MAC control unit 400 may evaluate the transmitter statistics. If the received data is burst data, the MAC control unit 400 further evaluates the pointer/length information provided in the control headers of the burst.

The MAC control unit 400 further extracts control information from the control header 430 which is intended for controlling the programmable physical layer interface 260. This control information is then forwarded to the programmable physical layer interface 260.

Thus, it is to be noted that a programmable MAC hardware control unit is provided that provides control information for both the MAC layer and the physical layer.

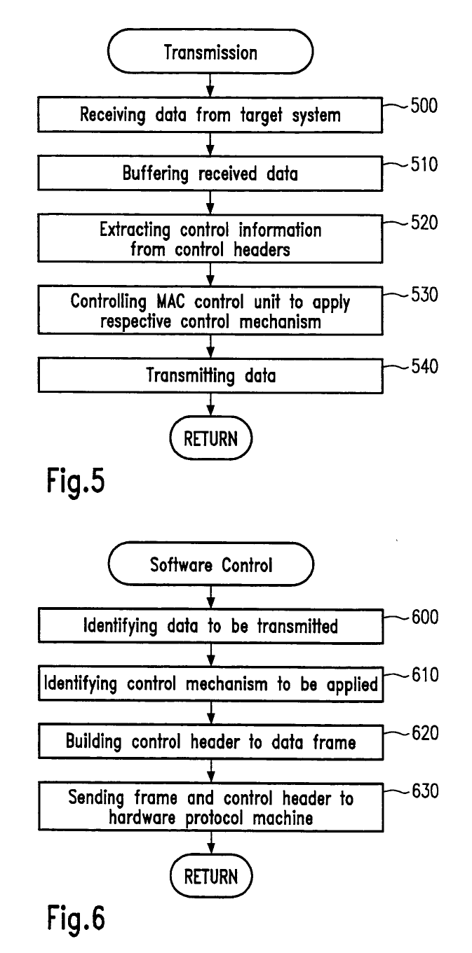

Turning now to the flow charts of FIGS. 5 and 6, the process of performing the MAC control according to the embodiments is depicted in more detail. Referring first to FIG. 5, data is received in step 500 from the target system 200. The received data is then buffered in step 510 in the transmission buffer 410. Once control information from the control headers is extracted in step 520, the MAC control unit 400 of the programmable MAC hardware unit 240 is controlled in step 530 to apply the one or more control mechanisms specified by the extracted control information. Finally, the data is transmitted in step 540 in compliance with the respective control mechanism(s).

FIG. 6 illustrates the software implemented control header building process according to an embodiment. In step 600, data to be transmitted is identified by the host processor 210. Then, the control mechanism which is to be applied to the identified data is identified in step 610. Then, the control header is built to the respective data frame in step 620, and the data frame and control header is sent to the hardware protocol machine 240 in step 630.

That is, the embodiments provide a technique where a control header is built by software to each frame, and the frame together with its control header is enqueued in a hardware queue. Thus, control information is provided to the hardware protocol machine in strong relationship to the data to which the control mechanism is to be applied. Since all of the control information needed by the hardware protocol machine is within the frame request control header, the point of time for updating the MAC control unit 400 of the hardware protocol machine is defined by the hardware itself so that any additional control effort is eliminated for the host 210.

In an embodiment, and referring to FIGS. 5 and 6, the host provides data to send (one or more frames) with attached control structure(s) as linked list into the system memory 220 or the optional on-chip memory 250 and informs the hardware only about the availability and where to find the begin of the list. The hardware may then decide by itself on the point in time to send, depending on the WLAN protocol, and download from memory.

While the invention has been described with respect to the physical embodiments constructed in accordance therewith, it will be apparent to those skilled in the art that various modifications, variations and improvements of the present invention may be made in the light of the above teachings and within the purview of the appended claims without departing from the spirit and intended scope of the invention. In addition, those areas in which it is believed that those of ordinary skill in the art are familiar, have not been described herein in order to not unnecessarily obscure the invention described herein. Accordingly, it is to be understood that the invention is not to be limited by the specific illustrative embodiments, but only by the scope of the appended claims.

1. A WLAN (Wireless Local Area Network) transmitter device comprising:
a transmission buffer for buffering data received from a target system, the buffered data comprising data to be transmitted over a wireless medium; and
a MAC (Medium Access Control) control unit for controlling access to said wireless medium,
wherein said MAC control unit is capable of selectively applying any one of at least two different control mechanisms to data to be transmitted,
wherein the data received from said target system comprises data frames each having associated an individual control header comprising control information, said control information specifying at least one control mechanism to be applied to data of the associated data frame, and
wherein said MAC control unit is arranged to extract control information from each control header associated to a data frame, and select a control mechanism specified by the extracted control information.

2. The WLAN transmitter device of claim 1, wherein said data frames are MSDU (MAC Service Data Unit) data frames.

3. The WLAN transmitter device of claim 2, further comprising a hardware queue for enqueuing requests comprising at least one MSDU data frame.

4. The WLAN transmitter device of claim 1, wherein said data frames are MMPDU (MAC Management Protocol Data Unit) data frames.

5. The WLAN transmitter device of claim 4, further comprising a hardware queue for enqueuing requests comprising at least one MMPDU data frame.

6. The WLAN transmitter device of claim 1, further comprising a hardware queue for enqueuing said data frames and associated control headers, wherein said control headers further comprise a pointer field for pointing to a respective next data frame enqueued in said transmission buffer.

7. The WLAN transmitter device of claim 6, wherein said control headers further comprise information indicating the length of the respective next data frame pointed to by said pointer field.

8. The WLAN transmitter device of claim 6, wherein said hardware queue is realized as on-chip memory.

9. The WLAN transmitter device of claim 1, further comprising a hardware queue for enqueuing said data frames and associated control headers, wherein said control headers further comprise a tag field indicating which one of the enqueued data frames is presently in service.

10. The WLAN transmitter device of claim 9, wherein said hardware queue is controlled by means of said tag field to operate as a wrap around counter.

11. The WLAN transmitter device of claim 1, wherein said MAC control unit is realized as microcomputerless, programmable hardware unit.

12. The WLAN transmitter device of claim 11, wherein said control information comprises MAC program information for programming said MAC control unit.

13. The WLAN transmitter device of claim 1, wherein said at least one control mechanism specified by said control information comprises a data security algorithm to be applied to data of the respective associated data frame.

14. The WLAN transmitter device of claim 1, wherein said at least one control mechanism specified by said control information comprises an RTS (Request To Send) frame control mechanism for transmitting an RTS frame prior to the respective associated data frame to be transmitted.

15. The WLAN transmitter device of claim 1, wherein said at least one control mechanism specified by said control information comprises an CTS (Clear To Send) frame control mechanism for transmitting an CTS frame prior to the respective associated data frame to be transmitted.

16. The WLAN transmitter device of claim 1, wherein said at least one control mechanism specified by said control information comprises a preamble control mechanism for specifying whether a preamble is to be transmitted prior to the respective associated data frame to be transmitted.

17. The WLAN transmitter device of claim 1, wherein said at least one control mechanism specified by said control information comprises a preamble type control mechanism for selecting a preamble type to be transmitted prior to the respective associated data frame to be transmitted.

18. The WLAN transmitter device of claim 1, wherein said at least one control mechanism specified by said control information comprises a unicast control mechanism for specifying whether the respective associated data frame is to be transmitted as unicast data frame.

19. The WLAN transmitter device of claim 1, wherein said control headers further comprise transmitter statistics data.

20. The WLAN transmitter device of claim 19, wherein said transmitter statistics data hold status information indicating whether a service was cancelled, successfully finished, or is not yet finished.

21. The WLAN transmitter device of claim 19, wherein said transmitter statistics data hold transmission retry information.

22. The WLAN transmitter device of claim 19, wherein said transmitter statistics data hold time stamp information taken at the transmission end of the last transmission.

23. The WLAN transmitter device of claim 19, wherein said transmitter statistics data hold previously received RSSI (Received Signal Strength Indication) information.

24. The WLAN transmitter device of claim 19, wherein said transmitter statistics data hold signal quality information pertaining to a previously received acknowledgment frame.

25. The WLAN transmitter device of claim 19, wherein said transmitter statistics data hold antenna selection information pertaining to a previously received acknowledgment frame.

26. The WLAN transmitter device of claim 1, further comprising a physical layer interface unit connected to said transmission buffer for receiving from said transmission buffer data to be transmitted,
wherein said physical layer interface unit is a programmable unit further connected to said MAC control unit for receiving from said MAC control unit physical layer interface program information for programming said physical layer interface unit.

27. The WLAN transmitter device of claim 1, adapted to receive data from said target system via a PCI (Peripheral Component Interconnect), CF (Compact Flash), SD (Secure Digital) and/or SRAM (Static Random Access Memory) compliant data interface.

28. The WLAN transmitter device of claim 1, being IEEE 802.11 compliant.

29. An integrated circuit chip comprising:
a transmission buffer circuit for buffering data received from a target system, the buffered data comprising data to be transmitted over a wireless medium; and
a MAC (Medium Access Control) control circuit for controlling access to said wireless medium,
wherein said MAC control circuit is capable of selectively applying any one of at least two different control mechanisms to data to be transmitted,
wherein the data received from said target system comprises data frames each having associated an individual control header comprising control information, said control information specifying at least one control mechanism to be applied to data of the associated data frame, and
wherein said MAC control circuit is arranged to extract control information from each control header associated to a data frame, and select a control mechanism specified by the extracted control information.

30. A method of operating a WLAN (Wireless Local Area Network) transmitter device, comprising:
receiving data from a target system, the data comprising data to be transmitted over a wireless medium;
buffering the received data; and
controlling access to said wireless medium by selectively applying any one of at least two different control mechanisms to data to be transmitted,
wherein the data received from said target system comprises data frames each having associated an individual control header comprising control information, said control information specifying at least one control mechanism to be applied to data of the associated data frame, and
wherein controlling access to said wireless medium comprises:
extracting control information from each control header associated to a data frame; and
selecting a control mechanism specified by the extracted control information.

31. The method of claim 30, wherein said data frames are MSDU (MAC Service Data Unit) data frames.

32. The method of claim 31, further comprising:
enqueuing requests in a hardware queue, said requests comprising at least one MSDU data frame.

33. The method of claim 30, wherein said data frames are MMPDU (MAC Management Protocol Data Unit) data frames.

34. The method of claim 33, further comprising:
enqueuing requests in a hardware queue, said requests comprising at least one MMPDU data frame.

35. The method of claim 30, further comprising:
enqueuing said data frames and associated control headers in a hardware queue, wherein said control headers further comprise a pointer field for pointing to a respective next data frame enqueued.

36. The method of claim 35, wherein said control headers further comprise information indicating the length of the respective next data frame pointed to by said pointer field.

37. The method of claim 35, wherein said hardware queue is realized as on-chip memory.

38. The method of claim 30, further comprising:
enqueuing said data frames and associated control headers in a hardware queue, wherein said control headers further comprise a tag field indicating which one of the enqueued data frames is presently in service.

39. The method of claim 38, further comprising:
controlling said hardware queue by means of said tag field to operate as a wrap around counter.

40. The method of claim 30, wherein controlling access to said wireless medium comprises operating microcomputerless, programmable hardware.

41. The method of claim 40, wherein said control information comprises MAC (Medium Access Control) program information for programming a MAC control unit.

42. The method of claim 30, wherein said at least one control mechanism specified by said control information comprises a data security algorithm to be applied to data of the respective associated data frame.

43. The method of claim 30, wherein said at least one control mechanism specified by said control information comprises an RTS (Request To Send) frame control mechanism for transmitting an RTS frame prior to the respective associated data frame to be transmitted.

44. The method of claim 30, wherein said at least one control mechanism specified by said control information comprises an CTS (Clear To Send) frame control mechanism for transmitting an CTS frame prior to the respective associated data frame to be transmitted.

45. The method of claim 30, wherein said at least one control mechanism specified by said control information comprises a preamble control mechanism for specifying whether a preamble is to be transmitted prior to the respective associated data frame to be transmitted.

46. The method of claim 30, wherein said at least one control mechanism specified by said control information comprises a preamble type control mechanism for selecting a preamble type to be transmitted prior to the respective associated data frame to be transmitted.

47. The method of claim 30, wherein said at least one control mechanism specified by said control information comprises a unicast control mechanism for specifying whether the respective associated data frame is to be transmitted as unicast data frame.

48. The method of claim 30, wherein said control headers further comprise transmitter statistics data.

49. The method of claim 48, wherein said transmitter statistics data hold status information indicating whether a service was cancelled, successfully finished, or is not yet finished.

50. The method of claim 48, wherein said transmitter statistics data hold transmission retry information.

51. The method of claim 48, wherein said transmitter statistics data hold time stamp information taken at the transmission end of the last transmission.

52. The method of claim 48, wherein said transmitter statistics data hold previously received RSSI (Received Signal Strength Indication) information.

53. The method of claim 48, wherein said transmitter statistics data hold signal quality information pertaining to a previously received acknowledgment frame.

54. The method of claim 48, wherein said transmitter statistics data hold antenna selection information pertaining to a previously received acknowledgment frame.

55. The method of claim 30, further comprising:
extracting physical layer interface program information from control headers for programming a physical layer interface unit.

56. The method of claim 30, wherein the data is received from said target system via a PCI (Peripheral Component Interconnect), CF (Compact Flash), SD (Secure Digital) and/or SRAM (Static Random Access Memory) compliant data interface.

57. The method of claim 30, for operating an IEEE 802.11 compliant WLAN transmitter device.

58. A computer readable storage medium storing instructions that, when executed on a processor, cause the processor to associate individual control headers to individual data frames to be sent to a WLAN (Wireless Local Area Network) communication device, said individual control headers containing control information specifying at least one of at least two different control mechanisms to be applied to data of the associated data frame by a MAC (Medium Access Control) control unit of said WLAN communication device.

59. A method of controlling operation of a WLAN (Wireless Local Area Network) communication device, comprising:
associating individual control headers to individual data frames to be sent to said WLAN communication device, said individual control headers containing control information specifying at least one of at least two different control mechanisms to be applied to data of the associated data frame by a MAC (Medium Access Control) control unit of said WLAN communication device; and
sending the data frames and associated control headers to said WLAN communication device.
